(19) United States
(12) Patent Application Publication
(10) Pub. No.: US 2015/0066655 A1
(43) Pub. Date: Mar. 5, 2015

(54) NON-MONTARY COMPENSATION SCHEME FOR DIGITAL RIGHTS MANAGEMENT-FREE DIGITAL AUDIO FILE TRANSMISSIONS

(71) Applicant: ROBIN LEEDMAN, Sherman Oaks, CA (US)

(72) Inventor: ROBIN LEEDMAN, Sherman Oaks, CA (US)

(21) Appl. No.: 14/018,300

(22) Filed: Sep. 4, 2013

(51) Int. Cl. G06Q 20/12; G06Q 50/18; G06Q 30/02

(52) U.S. Cl. CPC G06Q 20/1235; G06Q 30/0272; G06Q 50/184
USPC 705/14.68

(57) ABSTRACT

The present disclosure relates generally to the field of digital audio file downloading, and more particularly to digital rights management-free digital audio file downloading. A computing device receives a request for a digital audio file from a user, wherein the digital audio file is protected by intellectual property rights. The computing device requests that a digital advertisement having a viewing threshold be transmitted to the user for viewing. The computing device requests monetary credit for satisfaction of the viewing threshold from an owner, licensee, and/or assignee of the digital advertisement. The computing device credits an account associated with an owner, licensee, and/or assignee of the intellectual property rights with a monetary amount no greater than the requested monetary credit. The computing device services the request.

### BACKGROUND

The present disclosure relates generally to the field of digital audio file downloading, more particularly to digital rights management-free digital audio file downloading. A music download is the transferral of music from an Internet-facing computer or website to a user's local desktop computer. This term encompasses both legal downloads and downloads of copyright material without permission or legal payment. Popular online music stores that sell downloadable singles and albums include the iTunes Store®, Amazon MP3®, fairsharemusic, eMusic, Google Play®, CD Universe®, Nokia Music Store®, Tune App®, TuneTribe®, and Xbox Music®. Paid downloads are sometimes encoded with Digital Rights Management (hereinafter “DRM”) that restricts copying the music or playing purchased songs on certain digital audio players.

They are often compressed using a lossy codec (usually MPEG-1 Layer 3, Windows Media, or AAC), which reduces file size and bandwidth requirements. These music resources have been created as a response to expanding technology and needs of customers that wanted easy, quick access to music. Their business models respond to the “download revolution” by making legal services attractive for users.

DRM is a technology that allows an owner of an IP tangible, ebook/mp3/video games/ect., to control the use of digital content and devices after sale. For example, DRM can allow digital music to be only accessible on a particular device and/or for a predetermined duration. Some content providers claim that DRM is necessary to fight copyright infringement online and that it can help the copyright holder maintain artistic control or ensure continued revenue streams. Works can become permanently inaccessible if the DRM scheme changes or if the service is discontinued. Digital locks placed in accordance with DRM policies can also restrict users from doing something perfectly legal, such as making backup copies of CDs or DVDs, lending materials out through a library, accessing works in the public domain, or using copyrighted materials for research and education under fair use laws.

### SUMMARY

The present disclosure relates generally to the field of digital audio file downloading, and more particularly to digital rights management-free digital audio file downloading. A computing device receives a request for a digital audio file from a user, wherein the digital audio file is protected by intellectual property rights. The computing device requests that a digital advertisement having a viewing threshold be transmitted to the user for viewing. The computing device requests monetary credit for satisfaction of the viewing threshold from an owner, licensee, and/or assignee of the digital advertisement. The computing device credits an account associated with an owner, licensee, and/or assignee of the intellectual property rights with a monetary amount no greater than the requested monetary credit. The computing device services the request.

### BRIEF DESCRIPTION OF THE SEVERAL VIEWS OF THE DRAWINGS

FIG. 1 is a block diagram that depicts an environment, generally 100, in accordance with an embodiment of the present invention.

FIG. 2 illustrates various information transmissions that occur within environment 100, in accordance with an embodiment of the present invention.

FIG. 3 illustrates operational steps of a program function, inserted on an application server within the environment of FIG. 1, in accordance with an embodiment of the present invention.

FIG. 4 depicts a block diagram of components of a data processing system, in accordance with an embodiment of the present invention.

### DETAILED DESCRIPTION

The various method embodiments of the invention will be generally implemented by a computer executing a sequence of program instructions for carrying out the steps of the method, assuming all required data for processing is accessible to the computer. The sequence of program instructions may be embodied in a computer program product comprising media storing the program instructions. As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein. Alternatively, a specific use computer, containing specialized hardware for carrying out one or more of the functional tasks of the invention, could be utilized.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave, The computer usable program code may be transmitted using any appropriate medium, including but not limited to wireless, wireline, optical fiber cable, RF, etc.

The present invention is described below with reference to flow chart illustrations and/or block diagrams of methods, apparatus (systems) and computer program products according to embodiments of the invention. It will be understood that each block of the flow chart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

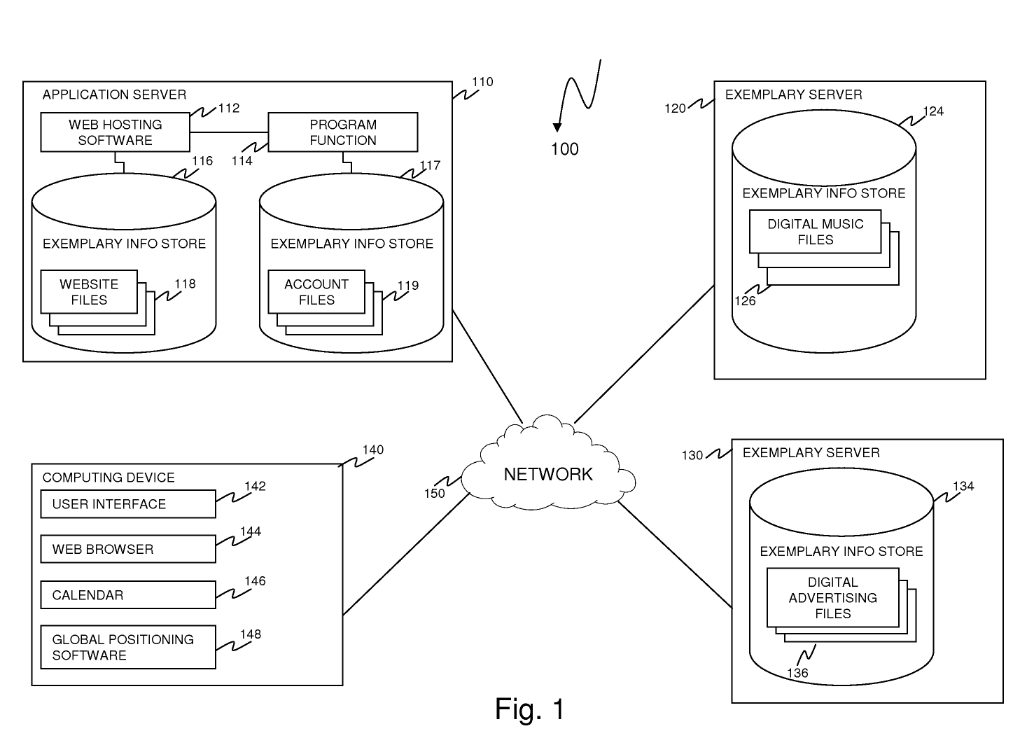

Embodiments of the present invention are described in detail with reference to the Figures. FIG. 1 is a block diagram that depicts an environment, generally 100, in accordance with an embodiment of the present invention. Environment 100 includes computing device 140, exemplary servers 120 and 130, and application server 110, all in communication via network 150. Network 150 allows computing devices, such as computing device 140, exemplary servers 120 and 130, and application server 110, to exchange data. Network 150 can be, for example, a local area network (LAN), a wide area network (WAN) such as the Internet, or a combination of the two, and can include wired, wireless, or fiber optic connections. In general, network 150 can be any combination of connections and protocols that will support communications between computing device 140, exemplary servers 120 and 130, and application server 110.

Exemplary information server 130 is in communication with exemplary server 130, computing device 140, and application server 110, in accordance with an embodiment of the present invention. Exemplary server 130 is a computing device that provides digital advertisements, in accordance with an embodiment of the present invention. Exemplary information server 130 includes exemplary information repository 134. Exemplary information repository 134 includes digital advertisement files 136. In an embodiment, digital advertisement files 136 include video images that have at least 480 horizontal lines of resolution. In another embodiment, digital advertisement files 136 include video images that have at least 570 lines of resolution. In an embodiment, resolution refers to the number of lines in the vertical display resolution. Exemplary server 130 provides digital advertisements to computing devices within environment 100, for example, computing device 140. Exemplary server 130 services requests received from application server 110, in accordance with an embodiment of the present invention. In general, exemplary information server 130 can be any computing device capable of servicing requests and providing digital advertisements, in accordance with an embodiment of the present invention.

Exemplary information server 120 is in communication with exemplary information server 130, computing device 140, and application server 110, in accordance with an embodiment of the present invention. Exemplary information server 120 is a computing device that provides digital music files to computing devices within environment 100, in accordance with an embodiment of the present invention. Exemplary information server 120 includes exemplary information store 124, which is an information repository. Exemplary information store 124 includes digital music files 126. Digital music files 126 include music covered by one or more intellectual property (hereinafter “IP”) rights that are property of an IP owner and/or licensee. An IP owner can consist of one or more persons and/or entities. Exemplary information server 120 services requests received from computing devices included in environment 100. In an embodiment, exemplary information server 120 services requests received from application server 110 by transmitting the requested digital music file included in exemplary info store 124. In general, Exemplary information server 120 can be any computing device capable of servicing requests received from application server 110, in accordance with an embodiment of the present invention.

Computing device 140 is in communication with application server 110 and exemplary servers 120 and 130, in accordance with an embodiment of the present invention. Computing device 140 is a computing device utilized by a user to request digital music files. Computing device 140 includes user interface 142 and web browser 144. User interface 142 allows a user to access websites included in website files 118 (discussed below) and/or request to download digital music, such as the digital music files 126. In certain embodiments, user interface 142 also allows a user to stream digital music. In an embodiment, user interface 142 may include hardware and/or software components. User interface 142 may be a graphics or text-based interface. Web browser 144 is a software application that a user of computing device 140 utilizes for retrieving, presenting, and traversing web pages, images, and/or video on a network, such as network 150.

In an embodiment, computing device 140 also includes calendar software 146 and/or global positioning software 148. Calendar software 146 that provides users of computing device 140 with an electronic version of a calendar as well as an appointment book, address book, and/or contact list. Global positioning software 148 provides users of computing device 140 with location-based services which determine the location of computing device 140, for example, by street, road, path, and/or latitude and longitude. Application server 110 is a computing device that provides website hosting services within environment 100, in accordance with an embodiment of the present invention. Application server 110 includes web hosting software 112 exemplary information stores 116 and 117, and program function 114. Application server 110 can send and receive information to another computing device included in environment 100 via network 150. In an embodiment, application server 110 is a virtual dedicated and/or a home server.

Web hosting software 112 is included in application server 110 and is in communication with exemplary information store 116. Exemplary information store 116 is an information repository that includes website files 118, which are the necessary files that comprise a website, such as a digital music retrieval website. For example, website files 118 includes files written in a plain text and/or a markup language, such as the Hypertext Markup Language. Website files 118 include files that may be accessed and transported with a protocol, such as the Hypertext Transfer Protocol. Website files 118 include web pages that are accessed using a locator, such as the Uniform Resource Locator. Web hosting software 112 makes web content that is included in website files 118 accessible to a network, such as network 150 and the World Wide Web. In an embodiment, web hosting software 112 provides internet hosting services. In another embodiment, web hosting software 112 provides web hosting services, which can include, but is not limited to, free, shared, reseller, managed, and colocation.

Web hosting software 112 is also in communication with program function 114. Program function 114 is further in communication with exemplary information store 117, which is an information repository that includes account files 119. Account files 119 are files that store an IP owner's compensation history. In an embodiment, the IP owner has direct and/or indirect access to account files 119. Each time a user views a digital advertisement for the duration of the predetermined viewing threshold, for example, sixty (60) seconds, the account of the IP owner that is associated with the requested digital music file is compensated. Program function 114 is software that allows a user to download and/or stream a DRM-free copy of a digital music file in exchange for viewing a digital advertisement for a predetermined period of time, in accordance with an embodiment of the present invention.

Program function 114, via network 150, instructs computing devices within environment 100, for example, exemplary servers 120 and 130, to transmit information, such as digital music files and digital advertisement files, to other computing devices that are included within environment 100, for example, computing device 140. Program function 114 receives, via network 150, requests for digital music file downloads and/or streaming from computing devices that are included within environment 100, such as computing device 140. Program function 114 transmits requests, via network 150, for compensation credit to computing devices included in environment 100. Program function 114 receives, via network 150, compensation credits from a computing device that is included in environment 100, such as exemplary server 130. Program function 114 determines whether users of computing devices that are included within environment 100 have satisfied a predetermined viewing threshold.

Program function 114 credits account files 114 according to a predetermined time period. In an embodiment, the predetermined time period is less than a minute, hour, day, week, month, or year. In another embodiment, program function 114 credits appropriate account files each time that associated compensation credit is received. In still other embodiments, program function 114 stores received compensation credits and adds the received compensation credits to appropriate account files according to a predetermined schedule, for example, hourly, weekly, monthly, quarterly, yearly. In an embodiment, program function 114 also transmits user analytics with the audio music file request that include geospacial information, browser history, calendar information, contacts list, streaming media viewing history, and/or social media information.

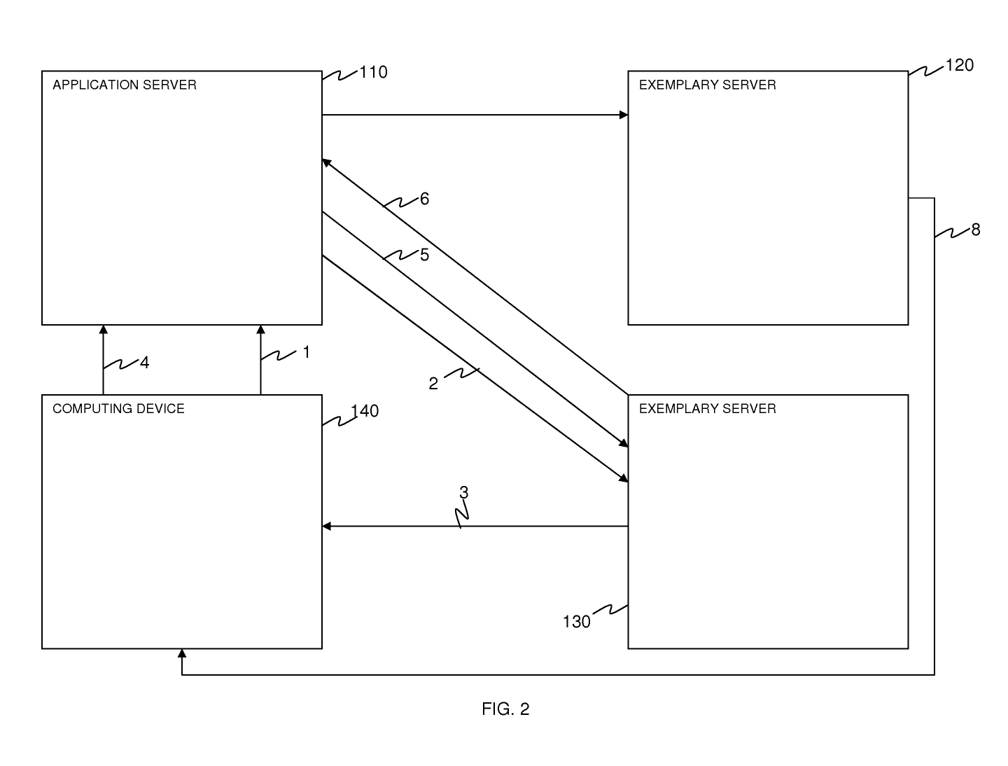

FIG. 2 illustrates various information transmissions that occur within environment 100, in accordance with an embodiment of the present invention. Specifically, FIG. 2 depicts the information transmissions that occur within environment 100 subsequent to a user visiting, via web browser 144, a website that is hosted on application server 110, for example, those websites included in website files 118, and browsing the digital music files that are available for downloading by title, genre, release date, producer, artist, IP licensee or IP owner. Information transmission 1 is initiated when the user selecting a digital music file for download and includes computing device 140 transmitting, via network 150, a request for the particular digital music file (hereinafter “digital music file download request”) to program function 114.

Program function 114 receives, via application server 110, the digital music file download request and in response initiates information transmission 2, which includes program function 114 transmitting a request to exemplary server 130 to transmit a HD-quality digital advertisement file that is included in, for example, digital advertisement files 136, to computing device 140 for viewing that is at least sixty (60) in duration. Exemplary server 130 receives the transmitted request and initiates information transmission 3, which includes exemplary information server 130 transmitting a HD-quality digital advertisement file that is at least sixty (60) seconds in duration. In an embodiment, the digital advertisements are standard definition.

In an embodiment, program function 114 provides a visual and/or audio indicator to user that indicates whether the user has satisfied the predetermined viewing threshold, for example, sixty seconds. The visual and/or audio indicator can be a countdown timer and/or indicate the amount of time that has lapsed since the received HD-quality digital advertisement file has played on computing device 140. In another embodiment, the visual and/or audio indicator is displayed in the same or different window compared to the received HD-quality digital advertisement file. The servicing of the digital music file download request can not proceed until program function 114 determines that the user has satisfied the predetermined viewing threshold, for example, by viewing the received HD-quality digital advertisement file for at least sixty (60) seconds.

In response to the satisfaction of the predetermined viewing threshold, computing device 140 transmits, via network 150, a notification to program function 114 that the predetermined viewing threshold has been satisfied (information transmission 4). In an embodiment, digital advertisement files 136 are sixty (60) seconds in duration and automatically instructs computing device 140 to notify program function 114 that the predetermined viewing threshold.

In other embodiment, digital advertisement files 136 are longer than sixty (60) seconds in duration and are required to be viewed for an amount of time that is at least equal to the predetermined viewing threshold. In another embodiment, when digital advertisement files 136 are longer than sixty (60) seconds in duration the notification that the predetermined viewing threshold has been satisfied can be automatically transmitted upon the satisfaction of the predetermined viewing threshold. In yet still another embodiment, when digital advertisement files 136 are longer than sixty (60) seconds in duration the notification that the predetermined viewing threshold has been satisfied is transmitted anytime after the satisfaction of the predetermined viewing threshold that the user stops playing the digital advertisement file.

In response to receiving the notification that the predetermined viewing threshold has been satisfied, program function 114 transmits a request for compensation credit to exemplary server 130 (information transmission 5). In an embodiment, program function 114 also transmits viewing analytics that are associated with viewing of the digital advertisement file by the user on computing device 140 to exemplary server 130. In response to receiving the request, exemplary server 130 services the request by transmitting, via network 150, the requested compensation credit to program function 114 (information transmission 6). In response to receiving the compensation credit, program function 114 adds the compensation credit to the account associated with the digital rights owner of the requested digital music file that is included in digital music files 126. Program function 114 transmits a notification that the appropriate IP owner account has been credited to exemplary server 120 (information transmission 7) and instructs exemplary server 120 to transmit the requested digital music file that is included in digital music files 126 to computing device 140.

In response to receiving the notification and the instructions, computing device 120 transmits, via network 150, the requested digital music file to computing device 140 (information transmission 8). The transmitted digital music file is DRM-free and may be freely copied and disseminated to individuals that may and/or may not have an affiliation with websites hosted by application server 110. In an embodiment, program function 114 instructs exemplary server 120 to make the requested digital audio file available for streaming to the user of computing device 140.

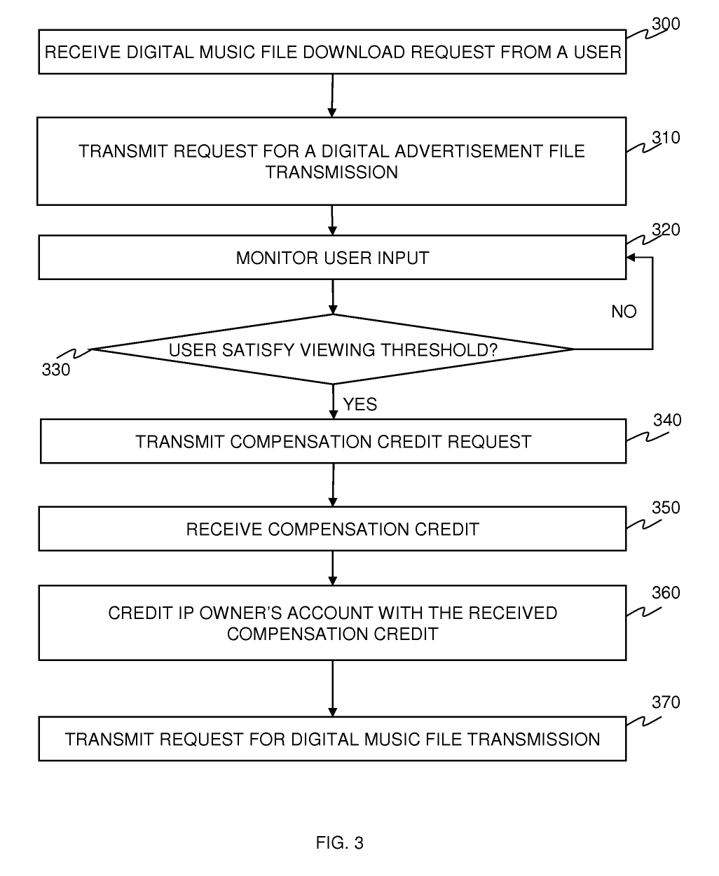

FIG. 3 illustrates operational steps of program function 114, inserted on application server 110 within environment 100 of FIG. 1, in accordance with an embodiment of the present invention. Program function 114 receives, via network 150, a digital music file download request from a user of computing device 140 (step 300). Program function 114 transmits a request for a digital advertisement file, such as a file included in digital advertisement files 136, transmission to computing device 140 (step 310). Program function 114 monitors input from the user of computing device 140 that corresponds to the viewing of the digital advertisement file (step 320). If program function 114 determines that the user has not satisfied the predetermined viewing threshold (“no” branch decisional 330), then program function continues to monitor user input (step 320). If program function 114 determines that the user has satisfied the predetermined viewing threshold (“yes” branch decisional 330), then program function 114 transmits a compensation request to exemplary server 130 (step 340). Program function 114 receives the requested compensation credit (step 350). Program function 114 credits the appropriate IP owner's account with the received compensation credit (step 360). Program function 114 transmits a request that the requested digital music file that is included in digital music files 124 be transmitted to computing device 140 for storage (step 370).

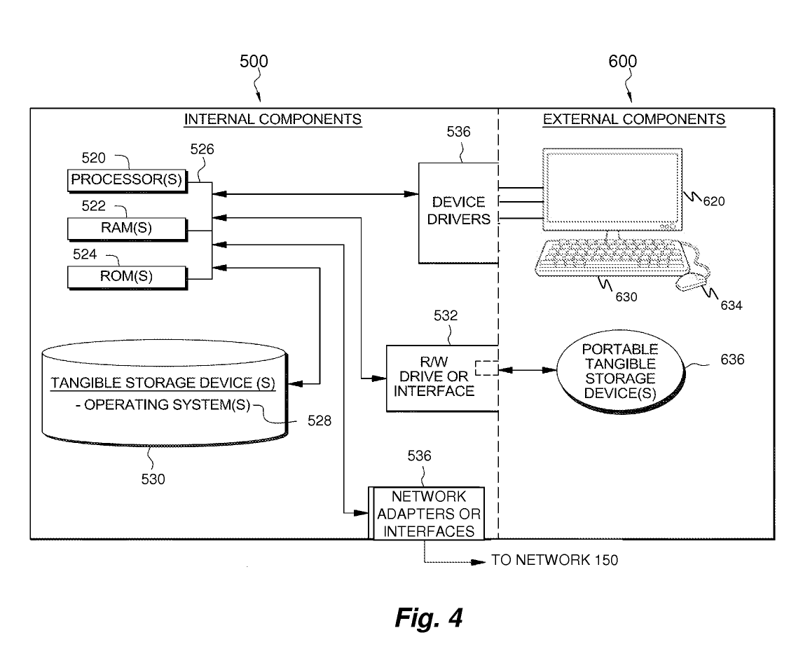

FIG. 4 shows a block diagram of the components of a data processing system 500, 600, such as application server 110, exemplary servers 120 and 130, or computing device 140, in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 500, 600 is representative of any electronic device capable of executing machine-readable program instructions. Data processing system 500, 600 may be representative of a smart phone, a computer system, PDA, or other electronic devices. Examples of computing systems, environments, and/or configurations that may represented by data processing system 500, 600 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Application server 110, exemplary servers 120 and 130, or computing device 140 includes respective sets of internal components 500 and external components 600 illustrated in FIG. 4. Each of the sets of internal components 500 includes one or more processors 520, one or more computer-readable RAMs 522 and one or more computer-readable ROMs 524 on one or more buses 526, and one or more operating systems 528 and one or more computer-readable tangible storage devices 530. The one or more operating systems 528, web hosting software 112, and program function 114, in application server 110; and web browser 144 in computing device 140 are stored on one or more of the respective computer-readable tangible storage devices 530 for execution by one or more of the respective processors 520 via one or more of the respective RAMs 522 (which typically include cache memory). In the embodiment illustrated in FIG. 4, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 500 also includes a R/W drive or interface 532 to read from and write to one or more portable computer-readable tangible storage devices 636 such as a CD-ROM, DVD, memory stick, magnetic tape, magnetic disk, optical disk or semiconductor storage device. website files 118 and account files 119 in application server 110; digital music files 126 in exemplary information server 120; and digital advertisement files 136 in exemplary information server 130 can be stored on one or more of the respective portable computer-readable tangible storage devices 636, read via the respective R/W drive or interface 532 and loaded into the respective computer-readable tangible storage devices 530.

Each set of internal components 500 also includes network adapters or interfaces 536 such as a TCP/IP adapter cards, wireless Wi-Fi interface cards, or 3G or 4G wireless interface cards or other wired or wireless communication links. Web hosting software 112 and program function 114 in application server 110; and web browser 144 in computing device 140 can be downloaded to application server 110 and computing device 140, respectively, from an external computer via a network (for example, the Internet, a local area network or other, wide area network) and respective network adapters or interfaces 536. From the network adapters or interfaces 536, Web hosting software 112 and program function 114 in application server 110; and web browser 144 in computing device 140 are loaded into the respective computer-readable tangible storage devices 530. The network may comprise copper wires, optical fibers, wireless transmission, routers, firewalls, switches, gateway computers and/or edge servers.

Each of the sets of external components 600 can include a computer display monitor 620, a keyboard 630, and a computer mouse 634. External components 600 can also include touch screens, virtual keyboards, touch pads, pointing devices, and other human interface devices. Each of the sets of internal components 500 also includes device drivers 540 to interface to computer display monitor 620, keyboard 630 and computer mouse 634. The device drivers 540, R/W drive or interface 532 and network adapters or interfaces 536 comprise hardware and software (stored in storage device 530 and/or ROM 524).

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A method comprising:
receiving, via a computing device, a request for a digital audio file from a user, wherein the digital audio file is protected by intellectual property rights;
requesting that a digital advertisement having a viewing threshold be transmitted to the user for viewing;
requesting monetary credit for satisfaction of the viewing threshold from an owner, licensee, and/or assignee of the digital advertisement;
crediting an account associated with an owner, licensee, and/or assignee of the intellectual property rights with a monetary amount no greater than the requested monetary credit;
servicing the request; and
wherein the digital advertisement is at least 60 seconds in duration;

2. The method of claim 1, wherein the digital audio file is associated with an electronic dance music genre.

3. The method of claim 1, wherein the digital advertisement is based on user-provided location based analytics.

4. The method of claim 1, wherein the digital advertisement includes a graphical indicator that is a time-based indicator that notifies the user when the viewing threshold has been satisfied.

5. The method of claim 1, wherein the servicing the request includes requesting that a digital rights management-free copy of the digital audio file be transmitted to the user for download.

6. The method of claim 1, wherein the requesting the digital advertisement transmission includes requesting a digital advertisement that is based on user analytics that include geospacial information, browser history, calendar information, contacts list, streaming media viewing history, and/or social media information.

7. The method of claim 1, wherein the servicing the request includes requesting that a copy of the digital audio file be made available to the user for streaming.

8. A computer program product, the computer program product comprising a computer readable storage medium having program code embodied therewith, the program code executable by a processor to:
receive a request for a digital audio file from a user, wherein the digital audio file is protected by intellectual property rights;
request that a digital advertisement having a viewing threshold be transmitted to the user for viewing;
request monetary credit for satisfaction of the viewing threshold from an owner, licensee, and/or assignee of the digital advertisement;
credit an account associated with an owner, licensee, and/or assignee of the intellectual property rights with a monetary amount no greater than the requested monetary credit;
service the request;
wherein the digital advertisement is at least 60 seconds in duration.

9. The computer program product of claim 8, wherein the digital advertisement includes a graphical indicator that is a time-based indicator that notifies the user when the viewing threshold has been satisfied.

10. The computer program product of claim 8, wherein the digital advertisement is based on user-provided location based analytics.

11. The computer program product of claim 8, wherein the digital advertisement includes a graphical indicator that is a time-based and/or notifies the user when the viewing threshold has been satisfied.

12. The computer program product of claim 8, wherein the program code to service the request includes program code to request that a digital rights management-free copy of the digital audio file be transmitted to the user for download.

13. The computer program product of claim 8, wherein the requesting the digital advertisement transmission includes requesting a digital advertisement that is based on user analytics that include geospacial information, browser history, calendar information, contacts list, streaming media viewing history, and/or social media information.

14. The computer program product of claim 8, wherein the program code to service the request includes program code to request that a copy of the digital audio file be made available to the user for streaming.

15. A computer system comprising:
one or more computer processors;
one or more computer-readable storage media;
program instructions stored on the computer-readable storage media for execution by at least one of the one or more processors, the program instructions comprising:
program instructions to
receive a request for a digital audio file from a user, wherein the digital audio file is protected by intellectual property rights;
request that a digital advertisement having a viewing threshold be transmitted to the user for viewing;
request monetary credit for satisfaction of the viewing threshold from an owner, licensee, and/or assignee of the digital advertisement;
credit an account associated with an owner, licensee, and/or assignee of the intellectual property rights with a monetary amount no greater than the requested monetary credit;
service the request; and
wherein the digital advertisement is at least 60 seconds in duration.

16. The computing system of claim 15, wherein the digital advertisement includes a graphical indicator that is a time-based indicator that notifies the user when the viewing threshold has been satisfied.

17. The computing system of claim 15, wherein the digital advertisement is based on user-provided location based analytics.

18. The computing system of claim 15, wherein the digital advertisement includes a graphical indicator that is a time-based and/or notifies the user when the viewing threshold has been satisfied.

19. The computing system of claim 15, wherein the program code to service the request includes program code to request that a digital rights management-free copy of the digital audio file be transmitted to the user for download and/or that a copy of the digital audio file be made available to the user for streaming.

20. The computing system of claim 15, wherein the program code to request the digital advertisement transmission includes requesting a digital advertisement that is based on user analytics that include geospacial information, browser history, calendar information, contacts list, streaming media viewing history, and/or social media information.
